(19) United States
(12) Patent Application Publication
(10) Pub. No.: US 2026/0366813 A1
(43) Pub. Date: Nov. 19, 2026

(54) Apparatus and Method for Producing at Least One Electrode, in Particular for a Storage Cell for Storing Electrical Energy

(71) Applicant: Bayerische Motoren Werke Aktiengesellschaft, Muenchen (DE)

(72) Inventors: Victor SCHOB, Stephanskirchen (DE); David SCHREINER, Garching b. Muenchen (DE)

(21) Appl. No.: 19/514,961

(22) PCT Filed: Jul. 17, 2024
(86) PCT No.: PCT/EP2024/070282

§ 371 Date: Feb. 27, 2026

(30) Foreign Application Priority Data
Aug. 31, 2023 (DE) 10 2023 123 490.0

(51) Int. Cl. F26B 13/10; F26B 21/35; F26B 21/37; H01M 4/04

(52) U.S. Cl. CPC F26B 13/10; F26B 21/35; F26B 21/37; H01M 4/0404

(57) ABSTRACT

An apparatus for producing an electrode has a dryer device for drying a coating web which has been applied to a conductor foil and which consists of an active material, and a receiving region in which the conductor foil coated with the coating web can be at least temporarily received for the purposes of drying the coating web. The dryer device has a plurality of outflow elements to which a heated gas can be supplied and from which the gas can be discharged, as a result of which the coating web can be acted upon by the heated gas for the purposes of drying the coating web. The dryer device has a distributor chamber which is common to the outflow elements and to which the heated gas can be supplied and via which the gas can be supplied to the outflow elements. The dryer device has a supply line through which the heated gas can flow and via which the heated gas flowing through the supply line can be supplied to the distributor chamber.

### BACKGROUND AND SUMMARY

The invention relates to an apparatus for producing at least one electrode, in particular for a storage cell for storing, in particular electrochemically storing, electrical energy. Further, the invention relates to a method for producing at least one electrode, in particular for a storage cell for storing, in particular electrochemically storing, electrical energy.

An electrode arrangement for a battery cell can be inferred as known from DE 10 2018 200 553 A1 . Furthermore, DE 10 2015 104 439 B4 discloses an electrochromic element. In addition, a method for producing an electrode is known from JP 6156398 B2 .

The object of the present invention is to provide an apparatus and a method so that an electrode, in particular for a storage cell for storing, in particular electrochemically storing, electrical energy can be produced particularly advantageously.

This object is achieved according to the invention by an apparatus and by a method having the features of the independent claims. Advantageous designs of the invention are the subject matter of the dependent claims.

A first aspect of the invention relates to an apparatus for producing at least one electrode, in particular for a storage cell for storing, in particular electrochemically storing, electrical energy. This means that the storage cell in its completely produced state comprises the electrode, wherein electrical energy is to be stored or is stored, in particular electrochemically, by means of or in the storage cell and in this case in particular by means of the electrode. The storage cell can in particular be a lithium-ion cell. In particular, it is conceivable that the apparatus is designed or used to produce the storage cell.

The apparatus comprises at least one dryer device, which is also referred to as a dryer line or can be designed as a dryer line. The dryer device is designed to dry at least one coating web made of an active material, which is applied to a conductor foil, which is in particular metallic. This means that to produce the electrode, in particular the storage cell, the coating web is applied to the conductor foil so that the conductor foil will be or is coated using the coating web. The coating web is formed here from the mentioned active material. The apparatus comprises at least one receptacle area here, in which the preferably metallic conductor foil, which is coated using the coating web and therefore provided with it, can be at least temporarily accommodated. This means that the conductor foil and the coating web applied to the conductor foil can be accommodated or are accommodated at least temporarily in the receptacle area of the apparatus, wherein the coating web applied to the conductor foil can be dried or is dried by means of the dryer device in the receptacle area, i.e. in particular while the conductor foil accommodated on the coating web is arranged or accommodated in the receptacle area.

In order to now be able to produce the electrode, in particular the storage cell, particularly advantageously, it is provided according to the invention that the dryer device comprises multiple outflow elements, also referred to as outflow units, which can be supplied with a heated gas. The heated gas can flow through the respective outflow element in a respective flow direction. The respective outflow element is also referred to as a nozzle and/or can be designed as a nozzle. The heated gas can be discharged from the outflow elements. This means that the respective outflow element can provide the heated gas such that the gas flows through the respective outflow element and in this case flows out of the outflow element and in particular flows, preferably directly, into the receptacle area. The heated gas can be applied, in particular directly, to the coating web to dry the coating web due to the discharge or delivery of the heated gas from the outflow elements. This means that the gas flowing out of the outflow elements and in particular thus flowing, in particular directly, into the receptacle area can flow against the coating web, in particular directly, in order to dry the coating web in this way, in particular while the coating web is arranged in the receptacle area, very particularly while the coating web and therefore the conductor foil are conveyed through the receptacle area.

The dryer device additionally comprises at least one distribution chamber, which is shared by the outflow elements and can be supplied with the heated gas. This means that the heated gas can be introduced into the distribution chamber, i.e. can be supplied to the distribution chamber. The heated gas can flow into the distribution chamber and thereupon flow through the distribution chamber and thereupon flow from the distribution chamber to the outflow elements, so that the gas is allocated or distributed to the outflow elements by means of the distribution chamber. The distribution chamber is therefore arranged upstream of the outflow elements in the flow direction of the gas flowing through the distribution chamber and the outflow elements. For example, the distribution chamber can also be supplied with a complete flow of the heated gas, also referred to as a complete stream, so that the complete flow of the heated gas can be introduced into the distribution chamber and therefore supplied to the distribution chamber. The complete flow is, for example, distributed or allocated to the outflow elements via the or by means of the distribution chamber such that the complete flow is split into partial flows, wherein precisely one of the partial flows can flow or does flow through the respective outflow element. The partial flows flowing through the outflow element can flow out of the outflow elements and flow into the receptacle area and flow against the coating web there, in particular directly, by which the coating web can be dried.

The dryer device additionally comprises at least one supply line through which the heated gas can flow and via which the distribution chamber can be supplied with the heated gas flowing through the supply line. Therefore, for example, the complete flow flows through the supply line and from the supply line into the distribution chamber, so that the supply line is arranged upstream of the distribution chamber in the flow direction of the heated gas flowing through the supply line, the distribution chamber, and the outflow elements. The distribution chamber is therefore arranged downstream of the supply line and upstream of the outflow elements in the flow direction of the heated gas flowing through the supply line, the distribution chamber, and the outflow elements. The distribution chamber is distinguished in particular in that it has a larger flow cross section through which the heated gas can flow considered in relation to the supply line and in relation to the respective outflow element alone. Therefore, if, for example, the supply line, the distribution chamber, and the outflow elements form a complete line through which the heated gas can flow, the distribution chamber thus forms, for example, a local cross-sectional enlargement, i.e. a local enlargement of a flow cross section through which the heated gas can flow on its path from the supply line via the distribution chamber to the respective outflow element.

The apparatus additionally comprises at least one volume and/or mass flow sensor arranged in the supply line, which is also referred to as the first sensor. A volume and/or mass flow of the heated gas flowing through the supply line is detectable by means of the first sensor, wherein the volume and/or mass flow detectable by means of the first sensor is also referred to as the first measured variable. The apparatus additionally comprises at least one first temperature sensor, which is arranged in the supply line or in the distribution chamber and is also referred to as the second sensor. The second sensor is preferably spaced apart from the first sensor. A temperature of the gas flowing through the supply line or the distribution chamber is detectable by means of the second sensor. The temperature detectable, i.e. to be measured, by means of the second sensor is also referred to as the second measured variable. The apparatus additionally comprises at least one second temperature sensor, by means of which a temperature of a surface of the coating web is detectable in a contactless manner in the dryer device. The second temperature sensor is also referred to as the third sensor. The temperature of the surface of the coating web detectable by means of the third sensor is also referred to as the third measured variable. The feature that the third sensor can detect, i.e. measure, the temperature of the coating web in a contactless manner is to be understood to mean that the temperature of the surface is detectable in a contactless manner with respect to the surface by means of the third sensor. In other words, the third sensor can detect or measure the temperature of the surface of the coating web without the third sensor touching the coating web. For example, the third sensor is designed as an infrared temperature sensor, in particular as an infrared pyrometer (IR pyrometer). The temperature of the surfaces of the coating web is also referred to as the surface temperature. The third sensor is very preferably spaced apart from the first sensor and from the second sensor. The third sensor is preferably arranged at an end of the receptacle area, in particular of the dryer device as a whole.

The apparatus additionally comprises at least one pressure sensor arranged in the supply line or in the distribution chamber, which is also referred to as the fourth sensor. A pressure of the gas flowing through the supply line or the distribution chamber can be detected by means of the fourth sensor, wherein the pressure detectable by means of the fourth sensor is also referred to as the fourth measured variable. In particular, the fourth measured variable is an absolute pressure of the gas flowing through the supply line or the distribution chamber. The fourth sensor is preferably spaced apart from the first sensor, the second sensor, and the third sensor.

The apparatus additionally comprises at least one differential pressure sensor, which is also referred to as the fifth sensor. A difference, also referred to as a pressure differential or pressure difference, between a first pressure prevailing in the surroundings and therefore outside the dryer device and a second pressure prevailing in the receptacle area and therefore in the dryer device can be detected, i.e. measured, by means of the fifth sensor, wherein the difference between the first pressure and the second pressure is also referred to as the fifth measured variable. Overall, it can be seen that the sensors can detect, i.e. measure, the measured variables, in particular while the coating web is being dried in the receptacle area. The drying of the coating web is also referred to as a drying action or drying process, wherein the apparatus according to the invention enables the drying process to be monitored in that the measured variables are detected during the drying process. Online or inline monitoring of the drying process is therefore possible, so that the electrode can be produced with a particularly high quality and with process reliability.

The sensors mentioned form a measurement technology or are part of a measurement technology, wherein the measured variables are detected or can be detected by means of the measurement technology, in particular during the drying process, i.e. while the coating web is being dried in the dryer device. The measurement technology is therefore also referred to as online or inline measurement technology. The invention is based on the finding here that without such an inline measurement technology, a quality of the electrode and/or the dryer device, i.e. at least one variable characterizing the quality of the electrode and/or dryer device, can only be determined after the dryer device and in particular only after the electrode has been completely produced. During the production of the electrode, for example, the in particular metallic conductor foil is unrolled from a winding, also referred to as a coil, thereupon coated, i.e. provided, with the coating web made of the active material, and thereupon conveyed through the dryer device, in particular through the receptacle area, so that, for example, the coating web applied to the conductor foil is dried in and by means of the dryer device, while the conductor foil and the coating web applied to the conductor foil are moved, in particular translationally, relative to the dryer device and at the same time conveyed through the receptacle area. The above-mentioned quality of the dryer device and/or electrode can typically only be determined after processing of the entire coil.

If quality problems are established in this case, the entire processed coil is considered to be a reject, which can result in a high rejection rate and therefore high costs in particular in a pilot line or standard line for producing electrodes. Therefore, monitoring the drying process is desirable, which can now be implemented by the invention. Quality features, such as an adhesive strength of the coating web on the conductor foil during the drying process, can be monitored by the detection, therefore measuring of the measured variables, for example, during the drying of the coating web, which is advantageous in particular insofar as the adhesive strength of the coating web on the conductor foil essentially arises in the drying process. The above-mentioned measured variables have been identified as particularly advantageous here to be able to monitor the drying process particularly advantageously and therefore be able to ensure a particularly high quality of the electrode produced and in particular of the drying process.

To be able to produce the electrode particularly advantageously, it is provided in one embodiment of the invention that the dryer device comprises at least one heating element, by means of which the gas can be heated. The heating element is preferably an electrical heating element, which can be supplied or is supplied with electrical energy in order to thus heat the gas via the heating element. The temperature of the gas can thus be deliberately set, for example.

Air is preferably used as the gas in order to avoid undesired negative impact on the coating web.

A further embodiment is distinguished in that the dryer device comprises at least one third temperature sensor as a sixth sensor, by means of which a temperature of the heating element itself is detectable. The temperature detectable by means of the sixth sensor is also referred to as the sixth measured variable, which can be detected, i.e. measured, by means of the sixth sensor. The drying process can thus be monitored particularly advantageously, so that a particularly high quality of the drying process itself and of the electrode produced can be ensured. Excess rejects can therefore be avoided.

In a further, particularly advantageous embodiment of the invention, the dryer device comprises at least one discharge path, via which the gas can be discharged from the coating web and out of the receptacle area after the gas is applied to the coating web. If the gas is air, the gas flowing through the discharge path is also referred to as exhaust air. In this case, the apparatus comprises at least one second volume and/or mass flow sensor arranged in the discharge path as the seventh sensor, by means of which a volume and/or mass flow of the gas flowing through the discharge path is detectable. The volume and/or mass flow of the gas detectable by means of the seventh sensor is also referred to as the seventh measured variable, which can be detected, i.e. measured, by means of the seventh sensor. The drying process can be monitored particularly advantageously in this way, so that a particularly high quality of the drying process and of the electrode can be ensured.

A further embodiment is distinguished by a conveyor device, by means of which the conductor foil coated with the coating web can be moved, in particular translationally, and thus can be conveyed through the receptacle area. The coating web applied to the conductor foil and the conductor foil provided, i.e. coated, with the coating web form a composite, also referred to as the electrode composite, in a state in which the coating web is applied to the conductor foil, the coating web of which is to be dried or is dried in the receptacle area by means of the dryer device. The coating web is therefore dried by means of the gas in the receptacle area and therefore in the dryer device while the composite is located in the receptacle area, in particular while the composite is moved through the receptacle area and therefore through the dryer device. The conveyor device is therefore designed to move the composite, in particular translationally, relative to the dryer device and in this way to convey the composite through the receptacle area while the coating web of the composite is dried by means of the gas such that the gas flowing out of the outflow elements and therefore provided by the outflow elements is applied, in particular directly, to the coating web of the composite, i.e. the gas flows against the coating web of the composite. The electrode can be produced with a high quality and with extra process reliability in this way.

A second aspect of the invention relates to a method for producing at least one electrode, in particular by means of an apparatus according to the first aspect of the invention. In the method according to the second aspect of the invention, at least one coating web made of an active material is applied to at least one conductor foil, which is metallic in particular, by which the conductor foil is provided, i.e. coated, with the coating web. In the method according to the second aspect of the invention, the conductor foil provided with the coating web is supplied to a receptacle area of a dryer device, by means of which the coating web is dried in the receptacle area. This means that in the method, the coating web is dried by means of the dryer device while the coating web applied to the conductor foil and therefore the conductor foil are located in the receptacle area, in particular are moved and therefore conveyed through the receptacle area. In the method according to the second aspect of the invention, the electrode is produced from the conductor foil provided with the coating web dried by means of the dryer line. In other words, as already described for the first aspect of the invention, the coating web applied to the conductor foil and the conductor foil provided with the coating web together form a composite, also referred to as an electrode composite, the coating web of which is dried in the receptacle area by means of the dryer device. After the drying of the coating web, the at least one electrode is produced from the composite.

To now avoid excessive rejects and therefore excessively high costs for producing the electrode and to be able to produce the electrode with process reliability at a high quality, it is provided in the second aspect of the invention that the dryer device comprises multiple outflow elements which are supplied with a heated gas and through which the heated gas flows, in particular in a respective flow direction. The flow directions in which the gas flows through the outflow elements preferably extend parallel to one another. In that the heated gas flows through the outflow elements, the heated gas flows out of the outflow elements and, in particular directly, into the receptacle area, by which the heated gas is applied, in particular directly, to the coating web for drying the coating web. This is to be understood in particular to mean that the heated gas flowing out of the outflow element flows against the coating web, in particular directly.

The apparatus additionally comprises at least one distribution chamber shared by the outflow elements, which is supplied with the heated gas and through which the heated gas flows. The heated gas is supplied via the distribution chamber to the outflow elements, in particular allocated to the outflow elements. The dryer device additionally comprises at least one supply line, through which the heated gas flows, which is supplied via the supply line to the distribution chamber, i.e. introduced into the distribution chamber. In this way, the distribution chamber is supplied with the heated gas via the supply line.

To be able to advantageously monitor the drying of the coating web, also referred to as the drying process, while the coating web is dried by means of the dryer device in the receptacle area, the apparatus comprises at least one volume and/or mass flow sensor arranged in the supply line, by means of which a volume and/or mass flow of the heated gas flowing through the supply line is detected during the drying of the coating web. The apparatus additionally comprises at least one first temperature sensor arranged in the supply line or in the distribution chamber, by means of which a temperature of the gas flowing through the supply line or the distribution chamber is detected during the drying of the coating web. The apparatus additionally comprises at least one second temperature sensor, by means of which a temperature of a surface of the coating web is detected in a contactless manner during the drying of the coating web in the dryer device. The apparatus additionally comprises at least one pressure sensor arranged in the supply line or in the distribution chamber, by means of which a pressure, in particular in the form of an absolute pressure, of the gas flowing through the supply line or the distribution chamber is detected during the drying of the coating web. Furthermore, the apparatus according to the second aspect of the invention comprises at least one differential pressure sensor, by means of which a difference between a first pressure prevailing in the surroundings and therefore outside the dryer device and a second pressure prevailing in the receptacle area and therefore inside the dryer device is detected during the drying of the coating web. Advantages and advantageous designs of the first aspect of the invention are to be viewed as advantages and advantageous designs of the second aspect of the invention and vice versa.

In order to be able to produce the electrode in a particularly high quality in a manner which is particularly favorable with respect to time and costs, it is provided in one embodiment of the second aspect of the invention that the conductor foil provided with the coating web, therefore the mentioned composite, is conveyed by means of a conveyor device through the receptacle area and therefore through the dryer device while the coating web is dried by means of the dryer device.

Further details of the invention result from the following description of a preferred exemplary embodiment using the associated drawing.

### BRIEF DESCRIPTION OF THE DRAWING

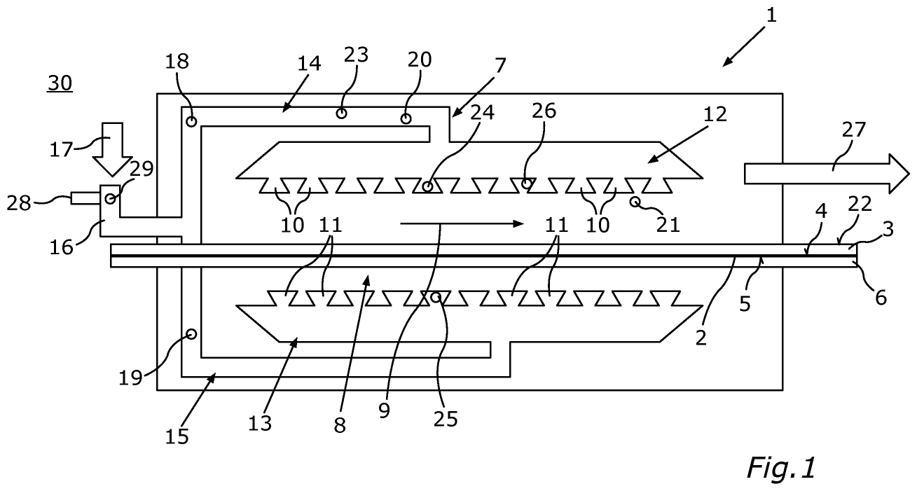

The single FIG. 1 shows a detail of a schematic and sectional side view of an apparatus for producing at least one electrode, in particular for a storage cell for storing, in particular electrochemically storing, electrical energy.

### DETAILED DESCRIPTION OF THE DRAWING

FIG. 1 shows a detail in a schematic side view of an apparatus 1 for producing at least one electrode, in particular for a storage cell for storing, in particular electrochemically storing, electrical energy. In addition, a method for producing the electrode is described hereinafter on the basis of FIG. 1. The electrode is used in particular after its production for the, or in, the mentioned storage cell, wherein electrical energy can be stored, in particular electrochemically, by means of the storage cell. For example, the storage cell is a lithium-ion cell. In the method and, for example, by means of the apparatus 1, at least one coating web 3 made of an active material is applied to at least one, preferably metallic conductor foil 2, so that the conductor foil 2 is provided, i.e. coated, with the coating web 3 and therefore with the active material.

In the exemplary embodiment shown in FIG. 1, the coating web 3 made of the active material is applied, in particular by means of the apparatus 1, to a first surface 4 of the conductor foil 2, so that the surface 4 is provided, i.e. coated, with the coating web 3. In addition, for example, in the method and in particular by means of the apparatus 1, a second coating web 6 made of the active material is applied to a second surface 5 of the conductor foil 2 facing away from the surface 4, so that, for example, the surface 5 is coated, i.e. provided, with the coating web 6 and therefore with the active material.

The apparatus 1 comprises a dryer device 7, which is also referred to as a dryer or dryer line. For example, the conductor foil 2 is provided with the coating webs 3 and 6 by means of a coating device, also referred to as a coating unit and not shown in FIG. 1, of the apparatus 1, in particular while the conductor foil 2 is moved, in particular translationally, relative to the coating unit by means of a conveyor device (not shown in FIG. 1) and therefore moved, i.e. conveyed, through the coating unit.

It can be seen from FIG. 1 that the dryer device 7 comprises a receptacle area 8, in which the conductor foil 2 coated with the coating webs 3 and 6 can be accommodated at least temporarily for drying the coating webs 3 and 6. In the method, the conductor foil 2 provided with the coating webs 3 and 6 is supplied to the receptacle area 8, and in the method, the coating webs 3 and 6 applied to the conductor foil 2, which are arranged on the surfaces 4 and 5 of the conductor foil 2 facing away from one another and therefore on sides of the conductor foil 2 facing away from one another, are dried by means of the dryer device 7, while the coating webs 3 and 6 applied to the conductor foil 2 are arranged in the receptacle area 8, in particular are conveyed through the receptacle area 8. This means that the coating webs 3 and 6 applied to the conductor foil 2 and the conductor foil 2 form a composite, also referred to as an electrode composite, which is moved, in particular translationally, by means of the conveyor device in a movement direction illustrated by an arrow 9 relative to the dryer device 7, and in this way moved, i.e. conveyed, in the conveying direction through the receptacle area 8, while the coating webs 3 and 6 of the composite are dried by means of the dryer device 7.

The apparatus 1 can comprise, for example, multiple dryer devices 7, which are also referred to as dryer segments. Multiple first ones of the dryer segments are arranged, for example, one behind another along the conveying direction illustrated by the arrow 9 and therefore in succession, in particular by forming a first dryer train. Multiple second ones of the dryer segments can be arranged, for example, in succession and therefore one behind another, in particular forming a second dryer train, through which, for example, a second composite can be conveyed in order to thus dry coating webs of the second composite while the second composite is conveyed through the second dryer train. A high number of electrodes can thus be produced in a manner favorable with respect to time and costs. The preceding and following statements on the dryer device 7 can also be transferred readily to the other dryer segments and vice versa.

After the coating webs 3 and 6 of the composite have been dried, the at least one electrode is produced from the composite, i.e. from the conductor foil 2 provided with the coating webs 3 and 6 dried by means of the dryer device 7.

To now be able to produce the electrode particularly advantageously, the dryer device 7 comprises first outflow elements 10 and second outflow elements 11, which are supplied with heated air as the heated gas and through which the heated air flows, in particular in a respective flow direction, which extends, for example, perpendicularly to the conveying direction. The heated air flows in the flow direction through the respective outflow element 10, 11 and out of the respective outflow element 10, 11, so that the heated air flows in the flow direction out of the respective outflow element 10, 11, i.e. is discharged. The respective outflow element 10, 11 is also referred to as an outflow unit. The heated air flowing out of the outflow units flows, in particular directly, into the receptacle area 8, so that the heated air flowing out of the outflow units flows directly against the coating webs 3 and 6 and is therefore applied directly thereto. The coating webs 3 and 6 are coated by this application of the heated air flowing out of the outflow units to the coating webs 3 and 6. It can be seen that the surfaces 4 and 5 and therefore the sides of the conductor foil 2 face away from one another along a direction extending perpendicularly to the conveying direction, wherein the respective flow direction coincides with the mentioned direction. The outflow elements 10 form a first outflow unit group here, and the outflow elements 11 form a second outflow unit group, wherein the outflow unit groups are opposite to one another along the direction, and wherein the composite is conveyed through in the conveying direction between the outflow unit groups while the coating webs 3 and 6 are dried by means of the heated air. In addition, it can be seen that the flow direction in which the heated air flows out of the respective outflow element 10 is opposite to the flow direction in which the heated air flows out of the respective outflow element 11.

The dryer device 7 comprises a first distribution chamber 12 shared by the outflow elements 10 and a second distribution chamber 13 shared by the outflow elements 11. The respective distribution chamber 12, 13 is supplied with the heated air and the heated air flows through it. The heated air is supplied via the distribution chamber 12 to the outflow elements 10 and via the distribution chamber 13 to the outflow elements 11, so that, for example, the heated air is allocated via the and by means of the distribution chamber 12 to the outflow elements 10 and via the and by means of the distribution chamber 12 to the outflow elements 11. Furthermore, the dryer device 7 comprises a first supply line 14, through which the heated gas flows, which is supplied via the first supply line 14 to the distribution chamber 12, i.e. is introduced into the distribution chamber 12, which is therefore supplied with the heated gas via the supply line 14. Furthermore, the dryer device 7 comprises a second supply line 15 assigned to the distribution chamber 13, through which the heated air flows, which is supplied by means of and via the second supply line 15 to the distribution chamber 13, i.e. is introduced into the distribution chamber 13. Therefore, the distribution chamber 13 is supplied with the heated air via the and by means of the supply line 15. Furthermore, the dryer device 7 comprises, for example, a common feed line 16 into supply lines 14 and 15, through which the heated gas flows. Via the and by means of the feed line 16, the supply lines 14 and 15 are supplied with the heated gas, which is therefore introduced via the feed line 16 into the supply lines 14 and 15. A flow of the air is illustrated by an arrow 17.

The dryer device 7 comprises a first volume flow sensor 18 arranged in the supply line 14, by means of which a volume flow of the heated air flowing through the supply line 14 is detected, i.e. measured, during the drying of the coating webs 3 and 6 and while the composite is conveyed through the receptacle area 8. Furthermore, the dryer device 7 comprises a second volume flow sensor 19 arranged in the supply line 15, by means of which a volume flow of the heated air flowing through the supply line 15 is detected, i.e. measured, during the drying of the coating webs 3 and 6. The dryer device 7 furthermore comprises, for example, a first temperature sensor 20 arranged in the supply line 14, which is arranged downstream of the volume flow sensor 18 in the flow direction of the heated gas (heated air) flowing through the supply line 14. By means of the temperature sensor 20, a temperature for the heated air flowing through the supply line 14 is detected during the drying of the coating webs 3 and 6. The dryer device 7 furthermore comprises a second temperature sensor 21, by means of which, in the dryer device 7, a temperature of a surface 22 of the coating web 3 is detected in a contactless manner during the drying of the coating webs 3 and 6. For this purpose, the temperature sensor 21 is designed, for example, as an infrared pyrometer. It can be seen that, for example, the temperature sensor 21 is arranged in the receptacle area 8. The dryer device 7 furthermore comprises a pressure sensor 23 arranged in the supply line 14, by means of which a pressure, in particular an absolute pressure, of the heated air flowing through the supply line 14 is detected, i.e. measured, during the drying of the coating webs 3 and 6. Furthermore, the dryer device 7 comprises a first differential pressure sensor 24, by means of which a difference between a first pressure prevailing in the surroundings 30 and therefore outside the dryer device 7 and a second pressure prevailing in the receptacle area 8 is detected, i.e. measured, during the drying of the coating webs 3 and 6.

In the exemplary embodiment shown in FIG. 1, the dryer device 7 additionally comprises a second differential pressure sensor 25, by means of which a difference between a third pressure prevailing in the surroundings 30 and a fourth pressure prevailing in the receptacle area 8 is detected during the drying of the coating webs 3 and 6.

In the exemplary embodiment shown in FIG. 1, the dryer device 7 additionally comprises a third temperature sensor 26. Multiple and therefore at least or precisely two temperature sensors 26 can be provided, which are arranged in succession, in particular spaced apart from one another, for example, along an arrangement direction. The arrangement direction preferably extends perpendicularly to the conveying direction and in a plane in which the conveying direction extends, wherein the conductor foil 2 extends in the plane, for example. Therefore, for example, the arrangement direction extends perpendicularly to the flow direction. The conductor foil 2, in particular the composite, in particular has a width extending along the arrangement direction, so that, for example, the temperature sensors 26 are arranged distributed over the width, also referred to as the web width. A temperature is detected, i.e. measured, in particular in a contactless manner, in particular in the receptacle area 8 and/or the surface 22, by means of the temperature sensor 26 and during the drying of the coating webs 3 and 6.

As illustrated by an arrow 27, the air, after the air has dried the coating webs 3 and 6, flows away from the coating webs 3 and 6 and, for example, out of the receptacle area 8, so that the air flows away from the coating webs 3 and 6 after the heated air is applied to the coating webs 3 and 6. This is illustrated by the arrow 27. A discharge path illustrated by the arrow 27 is provided here, via which the air is discharged from the coating webs 3 and 6 and in particular out of the receptacle area 8 after the air is applied to the coating webs 3 and 6. At least one volume and/or mass flow sensor is arranged here in the discharge path, for example, by means of which a volume and/or mass flow of the air flowing through the discharge path is detected in particular during the drying of the coating webs 3 and 6.

The dryer device 7 furthermore comprises a heating element 28, in particular an electrical heating element, which is arranged, for example, in the feed line 16. The air is heated by means of the heating element 28. A temperature sensor 29 is provided here, for example, by means of which a temperature of the heating element 28 itself is detected, i.e. measured, in particular during the drying of the coating webs 3 and 6 and in particular while the air is heated by means of the heating element 28.

The mentioned temperatures, volume flows, and differences and the mentioned pressure are measured variables which are measured while the coating webs 3 and 6 are being dried and while the composite is being conveyed through the receptacle area 8. The drying of the coating webs 3 and 6 is also referred to as the drying process. It is preferably provided that the electrode is produced depending on the measured variables. In particular, it is provided that the drying process is carried out depending on the measured variables. By way of example, the composite is guided through the receptacle area 8 depending on the measured variables.

### LIST OF REFERENCE NUMERALS

1 apparatus
2 conductor foil
3 coating web
4 surface
5 surface
6 coating web
7 dryer device
8 receptacle area
9 arrow
10 outflow element
11 outflow element
12 distribution chamber
13 distribution chamber
14 supply line
15 supply line
16 feed line
17 arrow
18 volume flow sensor
19 volume flow sensor
20 temperature sensor
21 temperature sensor
22 surface
23 pressure sensor
24 differential pressure sensor
25 differential pressure sensor
26 temperature sensor
27 arrow
28 heating element
29 temperature sensor
30 surroundings

1.-7. (canceled)

8. An apparatus for producing at least one electrode, comprising:
at least one dryer device for drying at least one coating web made of an active material applied to a conductor foil,
at least one receptacle area, in which the conductor foil coated with the coating web is accommodated, at least temporarily, for drying the coating web,
wherein the at least one dryer device comprises:
multiple outflow elements, which are supplied with a heated gas and from which the gas is discharged, due to which the heated gas is appliable to the coating web for drying the coating web;
a distribution chamber, which is shared by the multiple outflow elements and is supplied with the heated gas, and via which the multiple outflow elements are supplied with the gas;
a supply line, through which the heated gas can flow, and via which the distribution chamber is supplied with the heated gas flowing through the supply line;
at least one volume and/or mass flow sensor, which is arranged in the supply line, and by which a volume and/or a mass flow of the heated gas flowing through the supply line is detectable;
a first temperature sensor, which is arranged in the supply line or in the distribution chamber, and by which a temperature of the heated gas flowing through the supply line or the distribution chamber is detectable;
a second temperature sensor, by which a temperature of a surface of the coating web is detectable in a contactless manner in the dryer device;
a pressure sensor, which is arranged in the supply line or in the distribution chamber, and by which a pressure of the gas flowing through the supply line or the distribution chamber is detectable; and
a differential pressure sensor, by which a difference between a first pressure prevailing in surroundings of the dryer device and a second pressure prevailing in the receptacle area is detectable.

9. The apparatus according to claim 8, wherein the dryer device further comprises at least one heating element, by which the gas is heated.

10. The apparatus according to claim 9, wherein the dryer device further comprises a third temperature sensor, by which a temperature of the at least one heating element is detectable.

11. The apparatus according to claim 8, wherein the dryer device, further comprises:
a discharge path, via which the gas is discharged from the coating web and out of the receptacle area after the gas is applied to the coating web; and
a second volume and/or mass flow sensor, which is arranged in the discharge path and by which a volume and/or mass flow of the gas flowing through the discharge path is detectable.

12. The apparatus according to claim 8, further comprising:
a conveyor, by which the conductor foil coated with the coating web is conveyed through the receptacle area.

13. A method for producing at least one electrode, the method comprising:
applying at least one coating web made of an active material to at least one conductor foil;
supplying the conductor foil provided with the coating web to a receptacle area of a dryer device, by which the coating web is dried in the receptacle area; and
producing the electrode from the conductor foil provided with the coating web dried by the dryer device;
wherein drying of the coating web by the dryer device comprises:
multiple outflow elements, which are supplied with a heated gas and through which the heated gas flows, so as to be applied to the coating web to dry the coating web;
a distribution chamber shared by the multiple outflow elements, which distribution chamber is supplied with the heated gas and through which the heated gas flows, so as to be supplied to the multiple outflow elements;
a supply line, through which the heated gas flows, which is supplied to the distribution chamber via the supply line;
a volume and/or a mass flow sensor arranged in the supply line, by which a volume and/or mass of the heated gas flowing through the supply line is detected during the drying of the coating web;
a first temperature sensor arranged in the supply line or in the distribution chamber, by which a temperature of the gas flowing through the supply line or the distribution chamber is detected during the drying of the coating web;
a second temperature sensor, by which a temperature of a surface of the coating web is detected in a contactless manner in the dryer device during the drying of the coating web;
a pressure sensor arranged in the supply line or in the distribution chamber, by which a pressure of the gas flowing through the supply line or the distribution chamber is detected during the drying of the coating web; and
a differential pressure sensor, by which a difference between a first pressure prevailing in surroundings of the dryer device and a second pressure prevailing in the receptacle area is detected during the drying of the coating web.

14. The method according to claim 13, wherein
the conductor foil provided with the coating web is conveyed by a conveyor through the receptacle area and thus through the dryer device, while the coating web is dried by the dryer device.
